(19) United States
(12) Patent Application Publication
(10) Pub. No.: US 2022/0284485 A1
(43) Pub. Date: Sep. 8, 2022

(54) STRATIFIED SOCIAL REVIEW RECOMMENDATION

(71) Applicant: INTERNATIONAL BUSINESS MACHINES CORPORATION, ARMONK, NY (US)

(72) Inventors: Mary D. Swift, Rochester, NY (US); Irene Lizeth Manotas Gutiérrez, White Plains, NY (US); Jonathan D. Dunne, Dungarvan (IE)

(21) Appl. No.: 17/189,389

(22) Filed: Mar. 2, 2021

(51) Int. Cl. G06Q 30/02; G06F 40/20; G06N 3/04; G06Q 50/00

(52) U.S. Cl. CPC G06Q 30/0282; G06F 40/20; G06N 3/04; G06Q 50/01

(57) ABSTRACT

A computer receives reviews for an item from a plurality of sources. The computer may identify one or more key features of the item. The computer collects user preferences for the one or more key features of the item. The computer calculates odds ratio for each of the one or more key features of the item. The computer determines an affinity measure for each of the one or more key features based on the calculated odds ratio for each of the one or more key features of the item; and generates a forest plot for the item, where the forest plot comprises a summary measure determined using the affinity measure for each of the one or more key features.

### BACKGROUND

The present invention relates, generally, to the field of computing, and more particularly to integrating reviews in a single review model.

Multiple web sites and social platforms enable users to provide reviews about products or services. These reviews may vary in their form or scale and contain inputs in natural language and allow scoring using various scale models that represent satisfaction of the reviewer from the item, such as a 1-to-10 scale or star ratings. Additionally, many platforms allow users to post pictures or videos to accompany user-entered text reviews.

### SUMMARY

According to one embodiment, a method, computer system, and computer program product for association measure determination is provided. The present invention may include a computer receives reviews for an item from a plurality of sources. The computer may identify one or more key features of the item. The computer collects user preferences for the one or more key features of the item. The computer calculates odds ratio for each of the one or more key features of the item. The computer determines an affinity measure for each of the one or more key features based on the calculated odds ratio for each of the one or more key features of the item; and generates a forest plot for the item, where the forest plot comprises a summary measure determined using the affinity measure for each of the one or more key features.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating an association measure process according to at least one embodiment;

FIG. 3 depicts a forest plot of the calculated affinity measures of the item according to an embodiment of the present invention;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to integrating, by applying an odds ratio approach, reviews in a single review model. The following described exemplary embodiments provide a system, method, and program product to, among other things, receive reviews from different sources that have different formats and generate an association measure for affinity. This measure enables identification of reviewer bias in a standardized model, thus allowing for the generation of an unbiased item evaluation. Furthermore, this standardized model enables comparison and analysis of reviews in different formats that include natural language without a need for learning and adopting to each review format. Therefore, the present embodiment has the capacity to improve the technical field of natural language processing by analyzing and integrating reviews in different formats and, thus, enabling the computer or a user to determine a rating of the item in a single readable representation.

As previously described, multiple websites and social platforms enable users to provide reviews about products or services. These reviews may vary in their form or scale and contain inputs in natural language and allow scoring using various scale models that represent satisfaction of the reviewer from the item, such as a 1-to-10 scale or star ratings. Additionally, many platforms allow users to post pictures or videos to accompany user-entered text reviews.

Frequently, the item reviews across various platforms and online repositories are in different formats with different scales that include input in a natural language that is biased or generated by an interested consumer, which makes assessment of whether an item is an appropriate purchase difficult for both a human and a computing device. As such, it may be advantageous to, among other things, implement a system that apply weights to existing user preferences, analyzes reviews of the item from various sources to determine key features of the item, and integrates the weighted user preferences with the analyzed reviews into a single review measure having a range with the summary measure, that standardizes all the available reviews under one representation. For example, reviews from one source have numerical values while the other source has reviews in a natural language, the single review measure will analyze all of the reviews and represent them in a single view with identified key values where each value has a numerical representation.

According to one embodiment, an association measure process may collect reviews of an item from different sources and generate a review profile model based on the key features identified within each review. The key features are identified using a natural language processing model. Then, the affinity measure component may apply a weight to user preferences for each of the identified key features and after integration of the weighted user preferences for each of the key features generate a single review measure for the item. In addition, the association measure may calculate a summary measure and based on comparing it to a threshold value determine whether the item is the suitable item for the user.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to analyze reviews of an item from different sources, generate a summary measure that is standardized for any type of the item, and enables a user or a computing device to make a better determination as to item satisfaction of predetermined criteria.

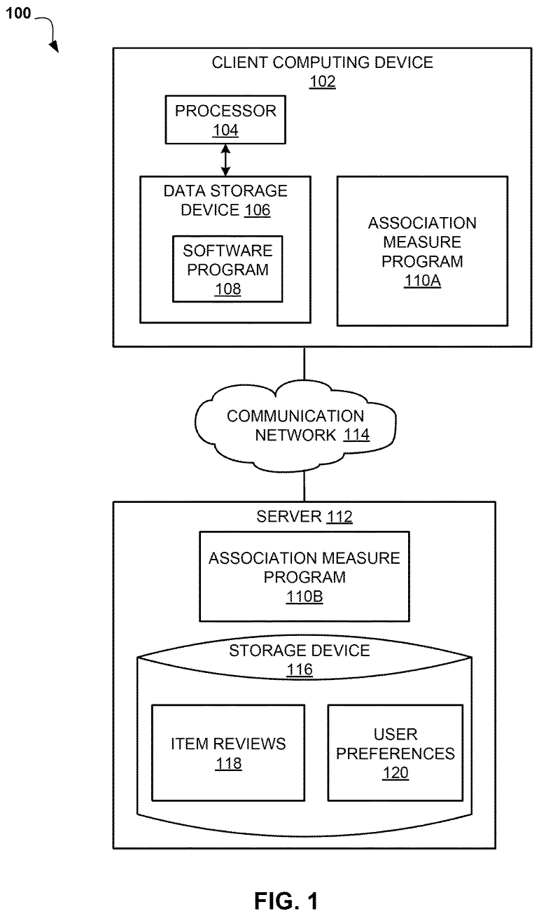

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

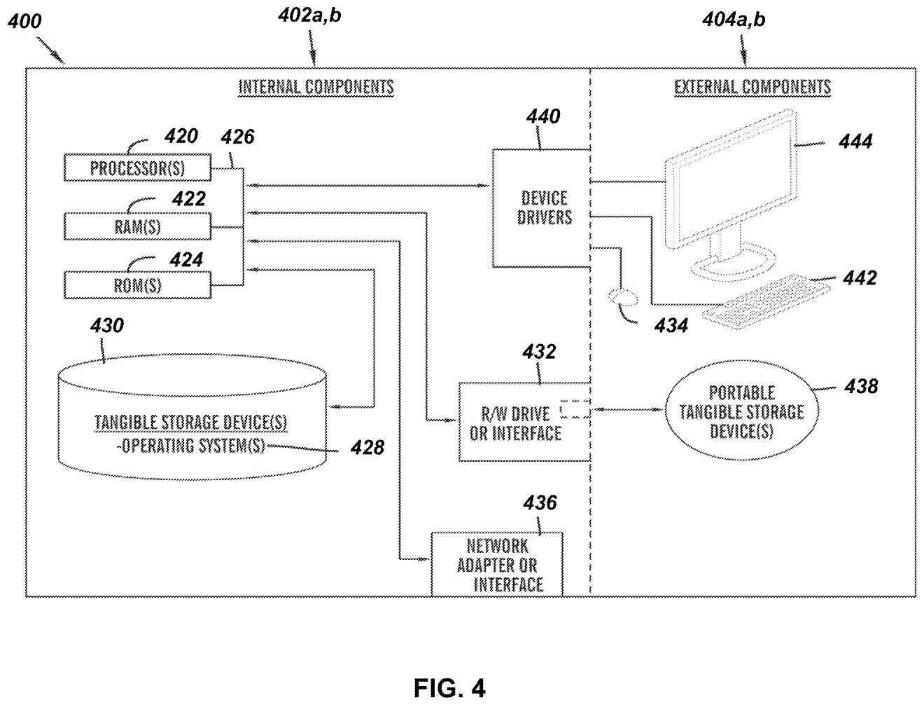

Client computing device 102 may include a processor 104 and a data storage device 106 that is enabled to host and run a software program 108 and an association measure program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running an association measure program 110B and a storage device 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

The storage device 116 may store item reviews 118 and user preferences 120. The item reviews 118 may be files or a database that stores reviews for an item in an unstructured format that was collected from various repositories. For example, if the item is a movie, the item reviews 118 may store scores and natural language items that represent user reviews for the movie that were downloaded from various servers via the internet. The user references 120 may be a file or a database representing user browsing history and/or user reviews of various items that the user reviewed over time.

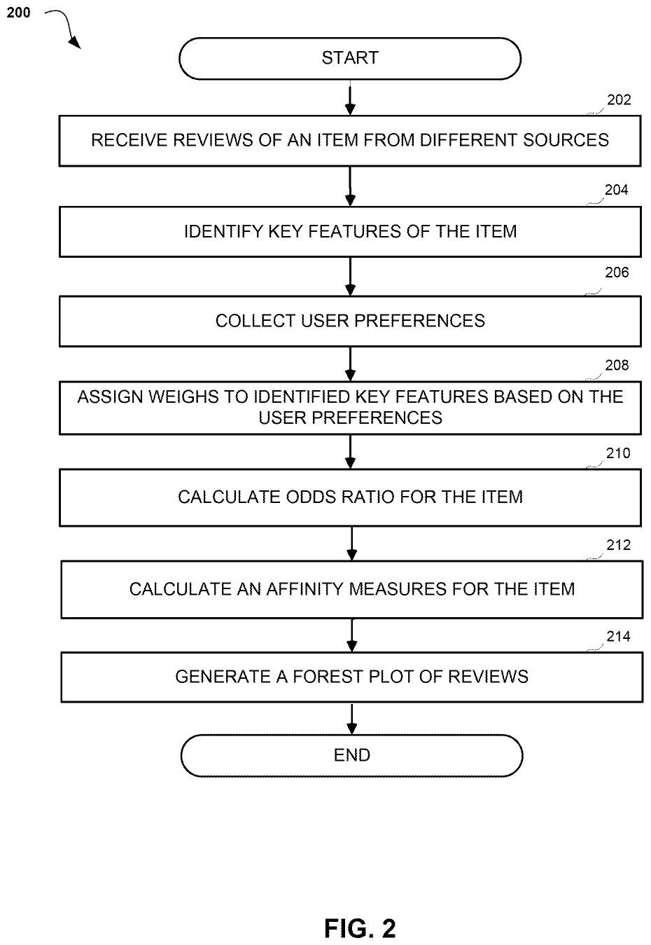

According to the present embodiment, the association measure program 110A, 110B may be a program that receives reviews for a specific item from different sources. The association measure program 110A, 110B may analyze the reviews using natural language processing in order to extract key features that define the item. Then the association measure program 110A, 110B may generate an association measure for affinity of the item using statistical analysis ad will be described in detail below. The association measure program 110A, 110B may determine user preferences to each of the key features and incorporate it into a single graph representing the scale and the ratings of each of the determined key features. Then, the association measure program 110A, 110B may present the graph including a summary measure. In alternative embodiment, the association measure program 110A, 110B may determine whether to select the item based on the summary measure being above a threshold value, predetermined by the user. The association measure method is explained in further detail below with respect to FIG. 2.

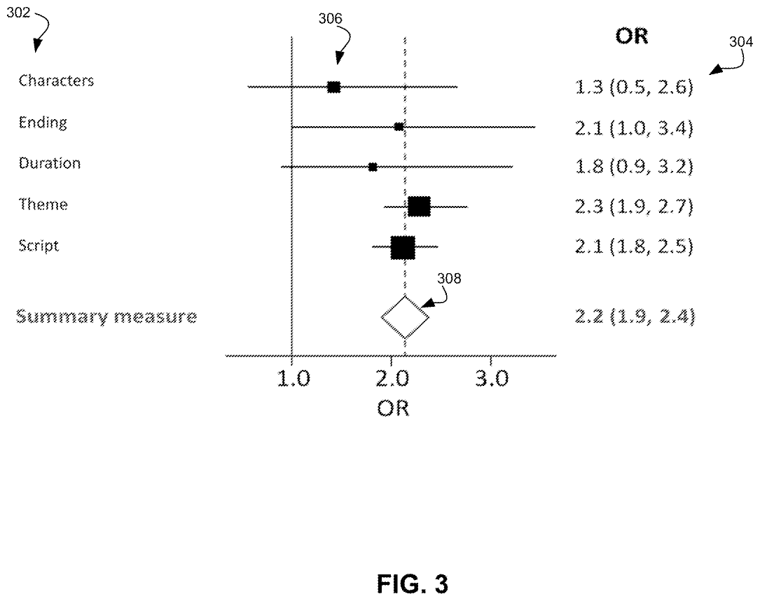

Referring now to FIG. 2, an operational flowchart illustrating an association measure process 200 is depicted according to at least one embodiment. At 202, the association measure program 110A, 110B receives reviews of an item from different sources. According to an example embodiment, the association measure program 110A, 110B may receive the reviews of an item by searching the Internet, such as by using web scraping and storing the reviews in the storage device 116 under item reviews 118. According to an example embodiment, an item may be any service or good that is reviewed by or on one or more websites over the Internet. For example, the association measure program 110A, 110B may access reviews of the item using Google® (Google® is a registered trademark of Google, Inc.) or Yelp® (Yelp® is a registered trademark of Yelp, Inc.). For example, if an item is a movie named as “Or” as depicted in FIG. 3, the association measure program 110A, 110B may receive the reviews for a movie from an available database such as IMDb® (IMDb® is a registered trademark of IMDB.COM, Inc.).

Next, at 204, the association measure program 110A, 110B identifies key features of the item. According to an example embodiment, the association measure program 110A, 110B may use a machine learning module, such as word embedding or a neural network module, to identify key features of the item from unstructured data in the item reviews 118. A neural network is a computational model in computer science that is based on a collection of neural units. Each neural unit is an artificial neuron that may be connected with other neural units to create a neural network. The neural network may then be trained to identify key features from the item reviews 118. The neural network may be a deep neural network that is a class of machine learning algorithms that uses multiple layers of neural networks to progressively extract higher-level features from a raw input, such as various reviews stored in the item reviews 118. Word embedding is a collective name for a set of language modeling and feature learning techniques in natural language processing (NLP) where words or phrases from a text are mapped to vectors or a set of coordinates of real numbers, using a trained neural network. The vectors may then be analyzed to identify the key features of an item, especially when the reviews comprise an input in a natural language. The key features may be important aspects of the item, such as price, size, length or assessed features (e.g., durability and results of the item). To continue the previous example, the association measure program 110A, 110B may analyze the natural language from the reviews and determine the key features of the movie such as characters, ending, duration, theme, and script as depicted in FIG. 4. In another embodiment, the association measure program 110A, 110B may identify the key features using a statistical approach, such as by frequency analysis of the natural language or by identifying the names of the scales from user reviews.

Then, at 206, the association measure program 110A, 110B collects user preferences. According to an example embodiment, the association measure program 110A, 110B may access user browsing history and user profile information on social networks and store all the available data under user preferences 120 for further processing. According to an example embodiment, the association measure program 110A, 110B may then analyze the user preferences 120 to identify the same key features identified in the item reviews 118 is step 204. For example, if a score of the item was identified as a part of the key feature in the item reviews 118, the association measure program 110A, 110B may identify a specific value the user was searching for or assigned to a similar item that is stored in the user preferences 120.

Next, at 208, the association measure program 110A, 110B assigns weights to identified key features based on the user preferences. According to an example embodiment, the association measure program 110A, 110B may assign weights to each of the identified key feature based on the values of the identified similar key features in the user preferences 120. For example, if one of the identified key features is length of the item and user preferences 120 have a specific history of length of the item than the identified length feature will have a higher weight associated with the length key feature. On the contrary, when one of the identified key features is color and user preferences 120 have no records related to the color of the item, the associated weight assigned to the color key feature will be the lowest. To continue the previous example, the association measure program 110A, 110B may determine from the user preferences 120 that the user prefers theme and script key features over other key features of the movie and thus, the weights associated with the theme and script of the movie would be higher, as depicted in FIG. 4, where larger rectangles represent higher values of the weights.

Then, at 210, the association measure program 110A, 110B calculates odds ratio for the item. According to an example embodiment, the association measure program 110A, 110B may transfer the identified key features into numerical values using word embedding, vectorization, or other known techniques and coupled with numerical values associated with each key feature weight, calculates the Mantel-Haenszel odds ratio for the item. The Mantel-Haenszel odds ratio alternatively known as Cochran-Mantel-Haenszel (CHM) test is used to analyze stratified or matched categorical data in order to determine an association between user preferences and key features. In another embodiment, the association measure program 110A, 110B may calculate the odds ratio for the item based on other models that compare user preferences to key features of the reviews, such as by using the McNemar test or other statistical models.

Next, at 212, the association measure program 110A, 110B calculates an affinity measure for the item. According to an example embodiment, the association measure program 110A, 110B may calculate the affinity measure for each of the identified key features based on user preferences and the calculated odds ratio of each of the identified key features of the item and after normalization may determine a summary measure using a weighted average model as depicted in FIG. 3.

Then, at 214, the association measure program 110A, 110B generates a forest plot of reviews. According to an example embodiment, the association measure program 110A, 110B may display the normalized values over a preferred scale affinity measure for each of the identified key features and the summary measure for the item as a forest plot. The forest plot is a model for displaying odds ratios including the summary measure inside the confidence intervals. To continue the previous example, a forest plot of the reviews for a specific movie “Or” is depicted in FIG. 3. In another embodiment, the association measure program 110A, 110B may place an order or purchase the item based on the summary measure value being above a predetermined threshold.

FIG. 3 depicts a forest plot of the determined affinity measures of the item according to an embodiment of the present invention. The forest plot may incorporate identified key features 302, calculated odds ratio 304 for each key feature, and a graphical representation of each range with an average value represented by a square 306 where the size of the square increases based on the associated weight of the key feature determined from user preferences. The summary measure 308 may be calculated as a weighted average and displayed below the graphical representation of each range.

It may be appreciated that FIGS. 2 and 3 provide only an illustration of one implementation and does not imply any limitations with regard to how different embodiments may be implemented. Many modifications to the depicted environments may be made based on design and implementation requirements.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the association measure program 110A in the client computing device 102, and the association measure program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the cognitive screen protection program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the association measure program 110A in the client computing device 102 and the association measure program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the association measure program 110A in the client computing device 102 and the association measure program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

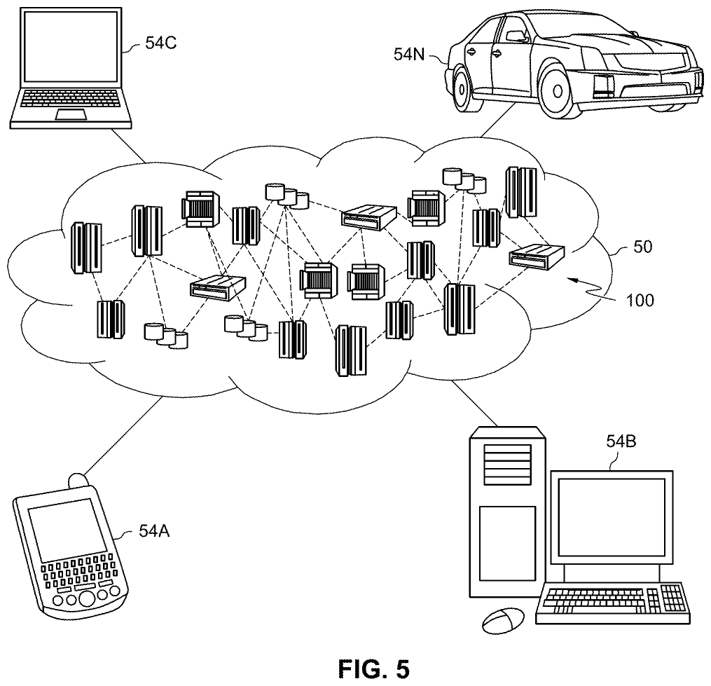

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

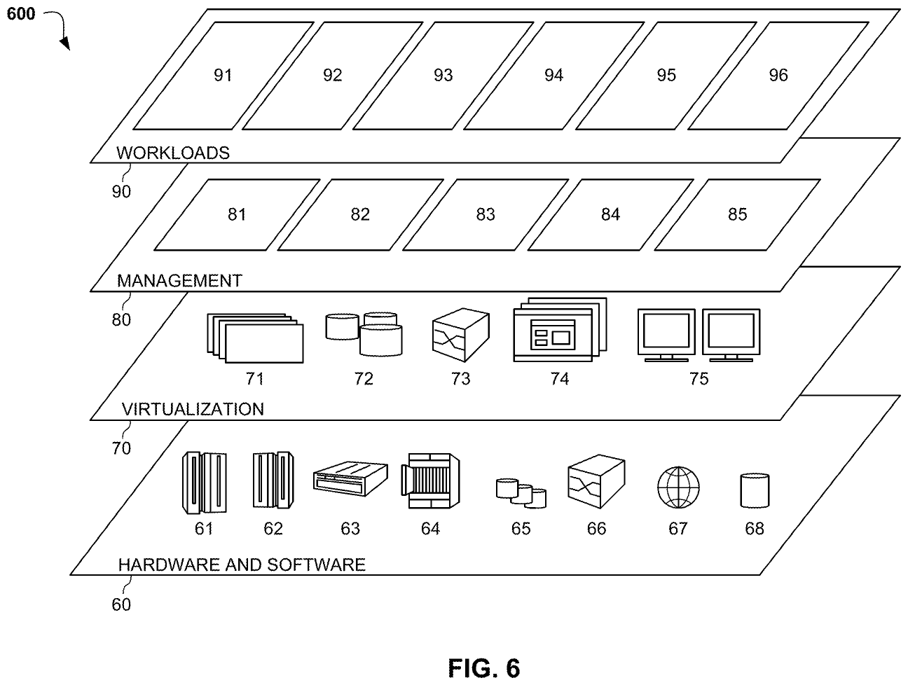

Referring now to FIG. 6, a set of functional abstraction layers 600 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and association measure determination 96. Association measure determination 96 may relate to analyzing reviews for an item from various sources by identifying key features of the item from the reviews and using odds ratio calculations generating a summary measure for the item.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for an association measure determination, the method comprising:
receiving reviews for an item from a plurality of sources;
identifying one or more key features of the item based on the received reviews;
collecting user preferences for the one or more key features of the item from browsing history and user profile information on social networks;
calculating an odds ratio for each of the one or more key features of the item;
calculating an affinity measure for each key feature based on the calculated odds ratio associated with each key feature of the item; and
generating a forest plot for the item, wherein the forest plot comprises a summary measure determined using the affinity measure for each key feature.

2. The method of claim 1, further comprising:
purchasing the item based on determining the summary measure is above a predetermined threshold.

3. The method of claim 1, wherein identifying the one or more key features of the item is by analyzing the reviews using a neural network.

4. The method of claim 1, wherein the odds ratio is a Mantel-Haenszel odds ratio.

5. The method of claim 1, wherein the reviews comprise an input in a natural language.

6. The method of claim 5, wherein the one or more key features are identified by analyzing the input in the natural language using word embedding.

7. The method of claim 5, wherein the one or more key features are identified using frequency analysis.

8. A computer system for an association measure determination, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving reviews for an item from a plurality of sources;
identifying one or more key features of the item based on the received reviews;
collecting user preferences for the one or more key features of the item from browsing history and user profile information on social networks;
calculating an odds ratio for each of the one or more key features of the item;
calculating an affinity measure for each key feature based on the calculated odds ratio associated with each key feature of the item; and
generating a forest plot for the item, wherein the forest plot comprises a summary measure determined using the affinity measure for each key feature.

9. The computer system of claim 8, further comprising:
purchasing the item based on determining the summary measure is above a predetermined threshold.

10. The computer system of claim 8, wherein identifying the one or more key features of the item is by analyzing the reviews using a neural network.

11. The computer system of claim 8, wherein the odds ratio is a Mantel-Haenszel odds ratio.

12. The computer system of claim 8, wherein the reviews comprise an input in a natural language.

13. The computer system of claim 12, wherein the one or more key features are identified by analyzing the input in the natural language using word embedding.

14. The computer system of claim 12, wherein the one or more key features are identified using frequency analysis.

15. A computer program product for an association measure determination, the computer program product comprising:
one or more computer-readable tangible storage medium and program instructions stored on at least one of the one or more tangible storage medium, the program instructions executable by a processor, the program instructions comprising:
program instructions to receive reviews for an item from a plurality of sources;
program instructions to identify one or more key features of the item based on the received reviews;
program instructions to collect user preferences for the one or more key features of the item from browsing history and user profile information on social networks;
program instructions to calculate an odds ratio for each of the one or more key features of the item;
program instructions to calculate an affinity measure for each key feature based on the calculated odds ratio associated with each key feature of the item; and
program instructions to generate a forest plot for the item, wherein the forest plot comprises a summary measure determined using the affinity measure for each key feature.

16. The computer program product of claim 15, further comprising:
program instructions to purchase the item based on determining the summary measure is above a predetermined threshold.

17. The computer program product of claim 15, wherein program instructions to identify the one or more key features of the item is by program instructions to analyze the reviews using a neural network.

18. The computer program product of claim 15, wherein the odds ratio is a Mantel-Haenszel odds ratio.

19. The computer program product of claim 15, wherein the reviews comprise an input in a natural language.

20. The computer program product of claim 19, wherein the one or more key features are identified by analyzing the input in the natural language using word embedding.
